(19) United States
(12) Patent Application Publication
(10) Pub. No.: US 2007/0106611 A1
(43) Pub. Date: May 10, 2007

(54) Method and system for preventing identity theft and providing credit independent completion of transactions

(76) Inventor: Christian P. Larsen, Alexandria, VA (US)

Correspondence Address: ARENT FOX PLLC, 1050 CONNECTICUT AVENUE, N.W., SUITE 400, WASHINGTON, DC, 20036, US

(21) Appl. No.: 11/269,752

(22) Filed: Nov. 9, 2005

(51) Int. Cl. G06Q 40/00

(52) U.S. Cl. 705/44; 705/39

(57) ABSTRACT

A method and system for preventing identity theft and providing an anonymous payment mechanism, such as a payment card, and for completing transactions using the mechanism. The payment mechanism is prepaid and has associated therewith an address, a unique identifier for the mechanism (e.g., card number), and a password. Transactions are completed by verifying the mechanism identifier, the provided address, and the provided password, and by verifying that a balance sufficient for the transaction remains in the account for the mechanism. Remote payment, such as via the Internet, may be accomplished by requiring delivery to the provided address. Variations allow replenishment of the account balance, cancellation of the card, including automatic cancellation after a predetermined time period, and for adding additional features, such as biometric identification.

BACKGROUND OF THE INVENTION

1. Field of the Invention

The present invention relates to a method and system for providing an identity and credit independent pre-paid payment mechanism, and in particular to a method and system for allowing completion of transactions using an anonymous payment card.

2 . Background of the Technology

There remains a problem in the existing art of identity theft, particularly for transactions over networks, such as the Internet. A solution is needed for those seeking to make payment on such networks to limit or eliminate risk in loss of such payments and to limit or eliminate any risk to such payer's credit.

There is a further unmet need in the prior art to provide individuals having poor or no credit histories and other credit difficulties with a method and system for completing transactions in which a credit card is normally used.

### SUMMARY OF THE INVENTION

The present invention meets the above needs, as well as others, by providing a method and system for enabling use of a payment mechanism, such as a card, that is identification free. In one embodiment, the payment mechanism includes a card that is anonymous and pre-paid, and that allows purchases and transactions to be performed at either teller, bank or retailer point of sale locations physically accessed, or if transacted remotely, such as over the Internet or telephone lines.

To enable the funding mechanism's use, funds are provided from a user seeking an account to a payment mechanism provider, such as a bank or other entity for maintaining accounts for the payment mechanism. The user also provides other information and/or other information is generated to be used for associating the payment mechanism with the user and the user's account for the mechanism. This other information can include, for example, a fixed mailing address for delivery of any items ordered using the payment mechanism, a billing mailing address, an email address, a unique identifier associated with the card, such as a randomly generated number, a credit card number, and a password optionally selected by the user. In embodiments of the present invention, unlike most existing credit and debit cards, the payment mechanism does not include the user's name.

When the payment mechanism takes the form of a card, it can include a magnetic strip, optical strip, smart card chip, or other feature for storing and communicating appropriate information for use with verification of transactions. For example, information contained on the card, such as the unique identifier, and the card number can be used with the user defined password and the user provided address information to supply sufficient secure information to complete a transaction without providing the user's identity.

Because the payment mechanism of the present invention is prepaid, no credit check or other credit verification by the user is necessary to obtain a card. In addition, the limitation on payment to the prepaid balance creates a built-in safety feature in the event of theft of the card, even if the identification information necessary to use the card is also lost. This feature enhances the usefulness of the card for purchases for less secure environments, such as payment via the Internet.

In some embodiments, the payment mechanism includes a cash payback feature, which is paid to the recipient at the address provided at the time the payment mechanism is purchased. This payment can occur, for example, at the time of accrual or upon expiration of the payment mechanism. In some embodiments, the payment mechanism automatically terminates upon expiration of a pre-determined period, such as 60 to 90 days (e.g., user defined) or upon a period of time passing with no transactions occurring. In some variations, the user can extend the life of the payment mechanism, such as by selecting an option upon verifying identity and accessing a telephone service (e.g., toll free number) or by accessing network site (e.g., an Internet website).

In some variations, the user is also able to accomplish other tasks via the telephone service or network site, such as recovering a lost password, checking account balance, or replenishing the account balance.

Embodiments of the present invention also include biometric features for further protection of the user. Such biometric features can include, for example, a photograph of the user that is included on the card face.

In some embodiments of the present invention, a pre-filled form is provided to obtain a card. The form can, for example, be provided at the location where the payment mechanism is obtained, accessed via a network, such as the Internet, or completed via response using an automated telephone system (e.g., interactive voice response, or IVR). In some embodiments, follow up contact of the user, such as by regular mail or a telephone call, is used to confirm account activation.

The payment mechanism may be used for a wide range of transactions. For example, over the Internet, the billing and shipping address must match the payment mechanism and account information, and, optionally, the user must reply to an email sent to the email address on file for the card as a verification step for completion of the transaction. For payment at a physical retail location or other physical location, for example, the payment mechanism may be swiped (e.g., if magnetic or optical strip enabled) or otherwise read for information, and the number on the card, the password and an 18 to 22 digit random code embedded in the card used to match the file for the account. Address information may also be used to verify the payment mechanism. This matching may be performed, for example, remotely, such as via a server on a network having access to database information for the account.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 shows various features of an example computer system for use in conjunction with an embodiment of the present invention;

FIG. 2 presents an exemplary system diagram of various hardware components and other features, in accordance with an embodiment of the present invention;

FIG. 3 contains an example flow diagram of functions performed in obtaining a payment mechanism, such as a card, in accordance with an embodiment of the present invention;

FIG. 4 shows an example flow diagram of functions for card balance replenishment, in accordance with an embodiment of the present invention;

FIG. 5 presents an example flow diagram of card termination functions, in accordance with an embodiment of the present invention; and

FIG. 6 shows an example flow diagram of various mechanism payment functions, in accordance with an embodiment of the present invention.

### DETAILED DESCRIPTION

The present invention solves the above identified problems of the prior art, as well as others, by providing a system and method for completing a transaction using a card or other payment mechanism, in an anonymous and non-credit dependent manner.

Embodiments of the present invention remove dependency of transaction completion on any personal data relating to a person's identity or credit profile, such as the person's name, or purchasing preferences, and Social Security number or other identifier. By removing such dependency on the user's identity and credit history, the present invention allows the user to make an anonymous, but secure payment over unsecure networks, such as the Internet. In addition, the present invention allows users, who may otherwise be unable to obtain a credit or debit card, to make purchases and complete transactions using a payment mechanism that is secure.

One embodiment of the present invention provides an anonymous card that has an associated prepaid value that cannot be replenished. The anonymous card of this embodiment is outwardly similar to a credit or debit card and optionally includes many features of standard credit or debit cards, such as having a magnetic or optical strip, self-contained chip (smart card), or other data storage and/or communication mechanism, so as to allow information to be communicated regarding the card and any value associated therewith, and having a card number (e.g., 16 digit number), similar to the credit or debit card number commonly embossed or otherwise appearing on a credit or debit card. The anonymous card of this embodiment differs from standard credit or debit cards, however, in that it contains no identity information associated with the card holder, such as the card holder's name.

In this embodiment, a prepaid value is associated with the card, and this prepaid value cannot be increased or replenished. In another embodiment, the anonymous card is similar to the first embodiment, but has an associated value that is replenishable.

The anonymous card of various embodiments of the present invention has associated therewith one or more physical addresses (interchangeably referred to herein as a “postal address” or “mail address”), an email address, and a password known to the user. The postal address may, for example, be the home address of the user or the address of a post office box or other postal address accessible by the user; separate addresses for delivery and for billing may also be provided. One purpose of the associated postal address for the anonymous card is to allow purchases to be delivered to a predetermined address (or only delivered to the predetermined address, such as for Internet-based purchases) supplied by the user. The email address and password serve as identifiers for the anonymous card that allow the user to link authorization for payment to the card, while maintaining the user's anonymity.

In one embodiment of the present invention, postal address information is not maintained (e.g., in memory) on the card, and the address associated with the card cannot be altered. The inalterable nature of the postal address associated with the card is to ensure that the card cannot be used by any other than the purchasing party. To further protect against theft of the card, loss of the card, or other failure to use the card within a predetermined time period, for example, the postal address is also used as the address for any refund of unexpended value associated with the card.

An exemplary description of a method and system for obtaining and utilizing a card in accordance with the present invention will now be described in further detail.

In this example, a card in accordance with the present invention is acquired, for example, at a participating bank or other financial institution. In embodiments of the present invention, a card is also obtainable at other locations, such as convenience stores, similarly to telephone cards that are typically similarly obtained. For example, automatic teller machines (ATMs) or other similar, specialized machines could be used to issue such cards, and the cards could be obtained via a network, such as the Internet. (Banks, financial institutions, and other participating entities using associated cards and other mechanisms, including methods for providing the card or other payment, are interchangeably referred to herein as “banks.”) In one embodiment, the a user would access the bank (such as by physical, telephone, or electronic access) and purchase a value amount for the card, such as by cashier's check, money order, cash, or electronic funds transfer. The user also provides at least a last name, a postal address, and, optionally, an email address, for example, to be associated with the card (individually and collectively interchangeably referred to herein as “identity information”).

A card (e.g., a plastic card having a magnetic or optical strip, a smart card, or other card having a mechanism or method for storing and/or retrieving data associated with the card) having the value purchased and having the associated identity information for the user, is then issued to the user by the bank. For example, in one embodiment, the bank or a separate entity (e.g., corporation formed for this purpose) maintains an individual account associated with the card, or a portion of a larger account (e.g., with subaccounts for individuals) maintained by the bank or separate entity is associated with the particular card.

Following purchase of the card, the user then activates the card. For example, in one embodiment, the user activates the card by calling a telephone number (e.g., 800 or other toll free number) or accessing a network site, and then providing the card number and a password. In one embodiment, the card cannot be activated by the bank at the time of purchase.

For variations that allow replenishment of the card, the telephone number or network site may also be used to replenish the card. For example, the user may use the telephone number or a website to access the user's account upon providing the card number and the password. In some embodiments, the user then is able to access balance information. In other embodiments, the user is able to add balance via such access, such as through electronic funds transfer. In these variations, however, the user cannot remove or transfer the balance; only merchants or other purchasees may access the account for balance removal or transfer.

Because any access to any account is so limited, even if a thief or other party misappropriating account information is able to obtain the identity information and password, the maximum risk for the user is the current use of the balance on the card for a purchase to be sent to the user's selected address.

With regard to a purchesee redeeming payment for a purchase made using the anonymous card, the mechanism for purchase differs for purchases made at a retail establishment versus those made via a network, such as the Internet. For a retail store payment, redemption is made using the credit card embossed number, information transmitted using the card read information (e.g., information read from the card's magnetic or optical information, or smart card chip), and a password supplied by the user. Typically, an amount of purchase is also supplied by the purchasee.

The card number is, for example, input by the purchasee at the point of sale, and the card read information is input, such as via a card reader. The user then provides a password and/or other identification information (e.g., randomly assigned identifier on the card or provided to the user), such as by entering the password on a keypad at the point of sale. These three items of information are transmitted, for example, to a remote location for verification. If the information matches database information for the account, the transaction is approved, and the approved value (e.g., money) is approved for reimbursement or otherwise transferred to the purchasee.

Information transmittal may occur, for example, via existing financial communication systems and devices, such as via Automatic Teller Machine (ATM) networks and credit card networks, so long as such systems and devices are capable of receiving additional identification information, such as a password. In addition, information transmittal may occur via a specialized network created for the specific verification functions of the present invention.

For purchases transacted remotely, such as via a network (e.g., the Internet) or a telephone communication, when billing information is provided, the user supplies the correct database address for both the billing address and the shipping address. One security feature of this aspect of the present invention is that the transaction cannot be completed unless the user knows the address associated with the card and is willing and able to receive the purchase at the same address. In addition to the card address information, the user must also provide the password associated with the card. The password information may be provided, for example, instead of the security code normally found on the reverse side of a standard credit card, or a separate input could be included in the billing system for receiving the password.

For example, a field on standard billing screens for all participating Internet merchants could be provided to receive a password to allow users of the card of the present invention to make purchases, or an option could be provided for users of cards of the present invention to select an alternate billing screen capable of receiving all information needed for use of the card of the present invention. In some embodiments of the present invention the additional field for the password could be encryptable to protect the password.

In an embodiment of the present invention, for all purchases, prior to completion of the transaction, sufficient available balance for the purchase is verified. For example, after verification of the input card number and identity information, an amount of the transaction may be input and communicated to a server containing the account balance information, and an approval or disapproval for the transaction returned to the merchant.

Embodiments of the present invention optionally further include a photograph or other biometric information for the user to provide additional identity verification.

For embodiments of the present invention that allow replenishment of the account balance, replenishment may be performed in any of a number of ways, so long as the card identity information is verified and a transfer amount provided. For example, in one exemplary embodiment, a network site, such as an Internet website, associated with the cards of the present invention is provided. At the site, the user is able to select a replenishment option and provides the card number, password, and address information to allow access to replenishment capability. For example, the user could provide electronic access for payment from a user bank account. In another embodiment, the user is able to mail or otherwise physically deliver cash, a check, credit card payment, or other payment option to the card purchase location or a postal delivery location. Such physical payment delivery is accompanied with the appropriate identity information for the card to be replenished.

The present invention also includes features to address the event of a user forgetting a password. In one embodiment, the user is able to access the account provider (e.g., via a network or telephone communication) and provide the card number and special code information (e.g., mother's maiden name maintained with the account) to enable replacement of the forgotten password.

In another embodiment, forgotten passwords become irrelevant due to an expiration feature for the account. For example, upon a predetermined time period (e.g., one year from the date of account opening; or after six months of the account remaining dormant), any remaining balance is returned via a check made out to the user. The name of the user may be provided, for example, at the time of expiration of the account, upon the user supplying the card, identity, and password information. Alternatively, the last name of the user may be provided at the time the card is obtained, and this provided last name used for any payments made from the account.

In some embodiments of the present invention, the user is provided with an option to accelerate liquidation of the account. For example, the user could select this option at a network site after providing appropriate card, identity, and password information. The liquidation payment would be made to the user address, similarly to the unaccelerated account expiration payment of balance.

In an embodiment of the present invention, the card account is interest bearing, allowing both the user and the account provider to obtain additional income from money in the account. For example, minimal interest could accrue based on an average balance in the account, or agreement by the user for non-use of the account or maintaining a minimum amount for a predetermined period (e.g., 60 or 90 days) could result in an interest payment. The interest feature enables the account to act as an anonymous savings or certificate of deposit account.

Additional benefits and incentives could also be provided to the user. For example, the user could receive points or a percentage back (e.g., 1 % cash back) on transactions. The points or percentage back could be paid, for example, by merchants (e.g., 3 % merchant charge) as a cost of participation in the card program. The remainder of this charge, after payment of cash back to the user, for example, would serve as a service fee for the card provider.

Embodiments of the present invention also include other features to allow the card provider to obtain payment related to providing card services. For example, a one time fee (e.g., $10 ) could be provided to the card provider at the time the card is obtained. The fee may also vary, depending on options provided with the card (e.g., additional fees for including user photograph or other biometric information; for enabling certificate of deposit capability; for obtaining longer card life period; for enabling replenishment feature). Additional fees could also be charged later, rather than at the time the card is obtained (e.g., additional charge upon replenishment event).

One feature of some embodiments of the present invention is that the user is unable to exceed the remaining balance on the card in any payment (i.e., the card does not enable credit functionality). This feature differs from typical prepaid credit cards and secured cards, which often allow card holders to at least minimally exceed remaining balances, although generally such events result in significant monetary penalties to the card holder.

Example embodiments will now be described in conjunction with the following figures.

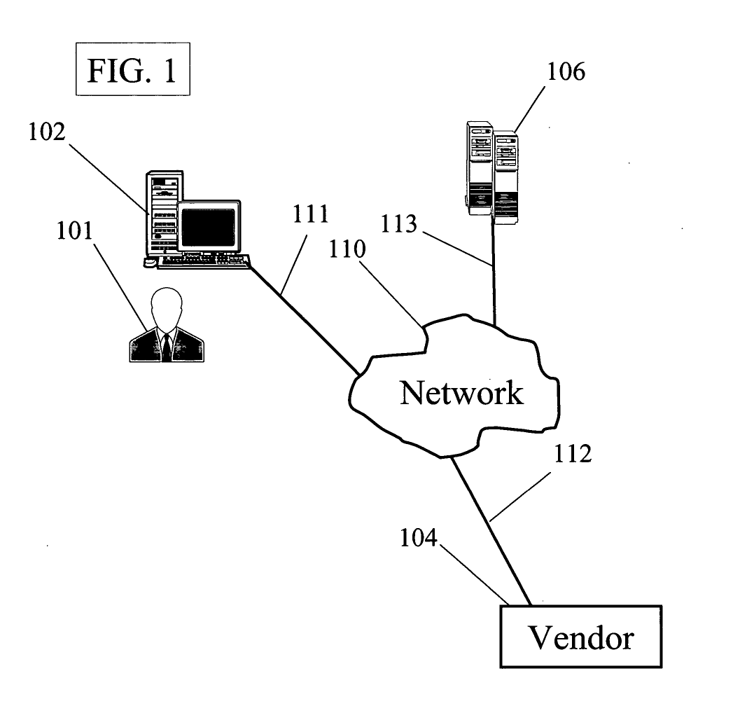

FIG. 1 shows various features of an example computer system 100 for use in conjunction with an embodiment of the present invention. As shown in FIG. 1, the computer system 100 is used by a requestor 101 or a representative of the requestor 101 to order goods or services from a vendor 104 via a terminal 102, such as a personal computer (PC), minicomputer, mainframe computer, microcomputer, telephone device, personal digital assistant (PDA), or other device having a processor and input capability. The system includes a server module 106 that includes functionality for billing and payment, among other functions. The server module comprises, for example, a PC, minicomputer, mainframe computer, microcomputer, or other device having a processor and a repository for data or that is capable of accessing a repository of data. The server module 106 is associated, for example, with the bank or other payment mechanism provider.

Information relating to a transaction via a network, 110, such as the Internet, is communicated between the requestor 101 and the vendor 104. Verification and other information is communicated between the vendor 104 and the server module 106. Communications are made, for example, via couplings 111, 112, 113, such as wired, wireless, or fiberoptic links.

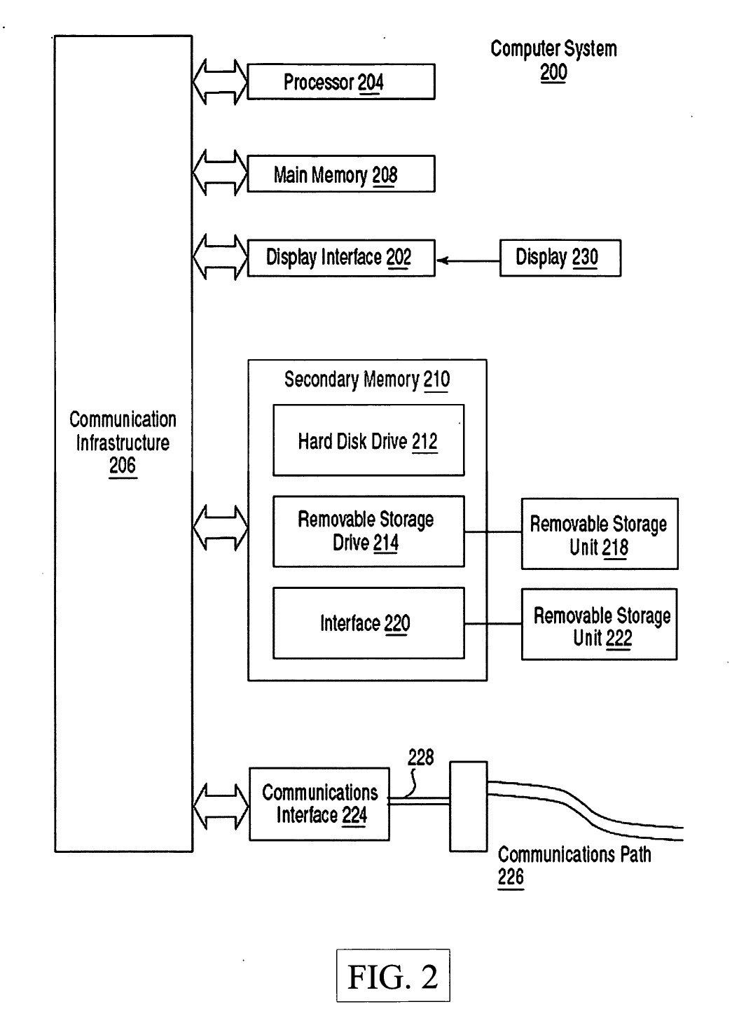

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

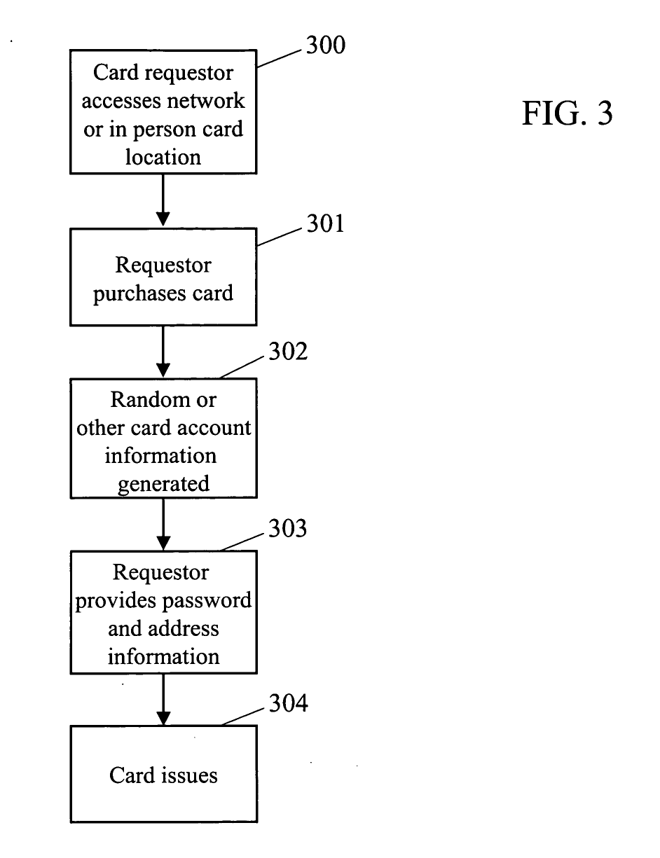

FIG. 3 contains an example flow diagram of functions performed in obtaining a payment mechanism, such as a card, in accordance with an embodiment of the present invention. As shown in FIG. 3, a card requestor or other potential user of the payment mechanism of the present invention obtains access to a mechanism provider 300, such as a bank, via in-person visit of the provider location or network access (e.g., access via a website on the Internet). The user purchases a payment mechanism 301, such as an anonymous card. A random account number of other number is generated to be associated with the payment mechanism 302 and, for example, may be stored on the card, such as via a magnetic strip, optical strip, or smart card memory. The user provides a password and address information 303 and other information that optionally may be provided to be associated with the payment mechanism account or otherwise associated with the payment mechanism, such as a last name and/or a photograph or other biometric identification information. The address information includes, for example, an address for delivery of goods and any payment (e.g., at account termination) and/or a billing address. The card then issues 304.

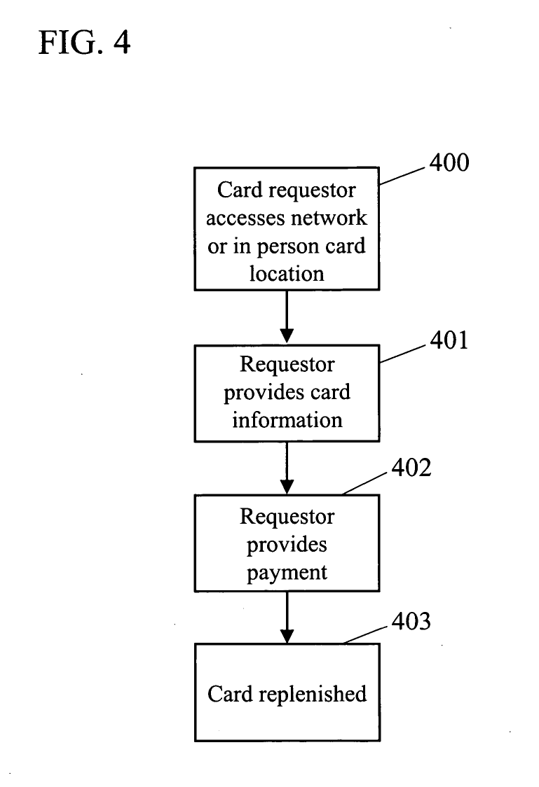

FIG. 4 shows an example flow diagram of functions for card balance replenishment, in accordance with an embodiment of the present invention. In FIG. 4, the card holder or other user of the payment mechanism of the present invention obtains access to a mechanism provider 400, such as a bank, via in-person visit of the provider location or network access (e.g., access via a website on the Internet). The user provides appropriate card information 401, so as to allow account access. The user then is able to access account information and perform selected functions 402, such as replenishment of the account balance (e.g., by making a payment or directing electronic payment from another account). Upon replenishment, the additional balance is usable via the card or other payment mechanism 403.

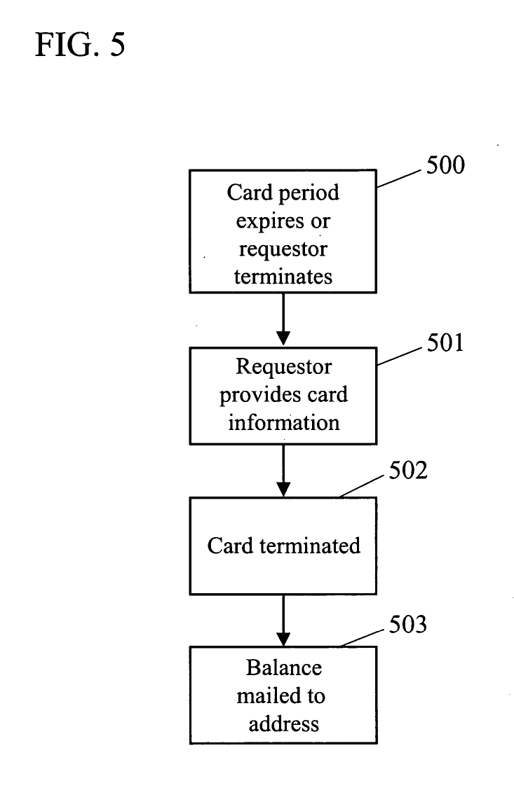

FIG. 5 presents an example flow diagram of card termination functions, in accordance with an embodiment of the present invention. In FIG. 5, upon a predetermined account period expiration or user selection of account termination occurring 500, the card holder or other user of the payment mechanism of the present invention obtains access to a mechanism provider, such as a bank, via in-person visit of the provider location or network access (e.g., access via a website on the Internet), and provides appropriate card information 501, so as to allow account access. The user is then able to access account information and perform selected functions 502, such as termination of the account. Upon selection of termination of the account and performance of any other required functions associated with such termination (e.g., providing a last name for any check to be issued for balance payment), the account is terminated. Any remaining balance is then distributed to the user 503.

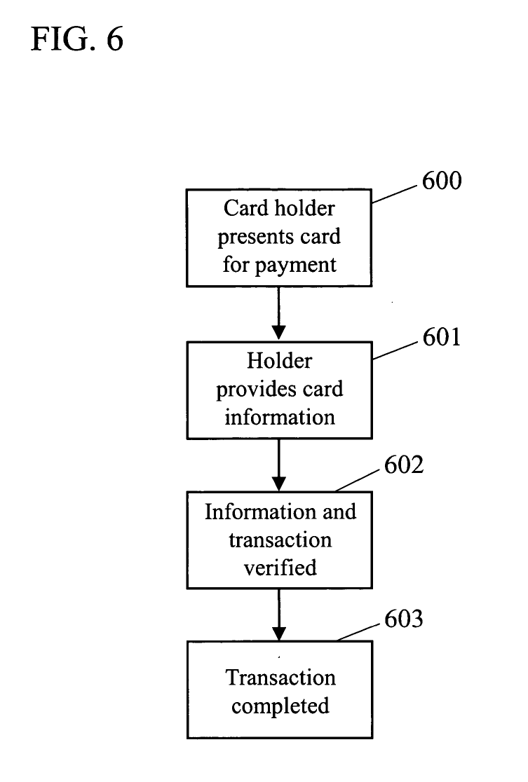

FIG. 6 shows an example flow diagram of various mechanism payment functions, in accordance with an embodiment of the present invention. As shown in FIG. 6, the card holder or other user of the payment mechanism of the present invention accesses a vendor 600, such as by presenting a card or other payment mechanism at a vendor physical location or by presenting payment mechanism information via a network, such as the Internet, to a network vendor. The user provides appropriate payment mechanism information 601, such as the card, for reading of information on the card, a password, an address associated with the account, and a payment amount. The payment mechanism information is then verified 602, such as via communication from the vendor to the server module of the payment mechanism information obtained from the user, comparison at the server module location of the obtained information to information for the account contained in a repository accessible by the server module, and communication from the server module to the vendor of approval or denial of the payment request. The communications may occur over a network, such as the Internet. The transaction is then completed 603, such as by either denial of the purchase upon denial of the payment request, or completion of the purchase upon approval of the payment request. Purchase completion can include, for example, submission of a request for funds transfer to the server module provider (e.g., by mailed bill information or network communication) and transfer of funds (e.g., by preparation of a check drawn on the account or electronic transfer of funds). The account balance is updated upon any fund transfer event (e.g., payment approval and/or actual payment) occurring.

Example embodiments of the present invention have now been described in accordance with the above advantages. It will be appreciated that these examples are merely illustrative of the invention. Many variations and modifications will be apparent to those skilled in the art.

1. A method for providing a payment mechanism for an account, the method comprising:
associating an address with the account;
assigning a unique identifier to the account;
receiving a funding amount associated with the account; and
providing the payment mechanism associated with the account.

2. The method of claim 1, wherein the address includes a mailing address.

3. The method of claim 1, wherein the address includes a billing address.

4. The method of claim 1, wherein the address includes an email address.

5. The method of claim 1, wherein the unique identifier includes a randomly assigned number.

6. The method of claim 1, wherein the unique identifier is stored on the payment mechanism.

7. The method of claim 1, wherein the unique identifier is a password.

8. The method of claim 7, wherein the password is received from the user.

9. The method of claim 1, wherein the funding amount is selected from a group consisting of a check, cash, a money order, a credit card payment, a debit card payment, and an electronic funds transfer.

10. The method of claim 1, wherein the payment mechanism is a card.

11. The method of claim 10, wherein the payment mechanism does not include a user identifier.

12. The method of claim 11, wherein the user identifier is a name.

13. The method of claim 1, further comprising:
receiving biometric information for the user.

14. The method of claim 13, wherein the biometric information is an image of the user.

15. The method of claim 13, wherein the payment mechanism is a card, and wherein the biometric information is contained on the card.

16. The method of claim 1, further comprising:
providing an option to replenish the funding amount.

17. The method of claim 16, wherein, if a selection of the option to replenish the funding amount is received, the method further comprises:
receiving a replenished funding amount associated with the account.

18. The method of claim 1, further comprising:
providing an option to terminate the account.

19. The method of claim 18, wherein, if a selection of the option to terminate the account is received, the method further comprises:
determining a remaining balance for the account; and
transferring a value equivalent to the remaining balance to an account holder for the account.

20. The method of claim 18, wherein the option to terminate the account is received automatically.

21. The method of claim 18, wherein the option to terminate is automatically received upon a predetermined time period passing.

22. The method of claim 1, further comprising:
facilitating a transaction between the account and a vendor account via the payment mechanism.

23. The method of claim 22, wherein facilitating a transaction between the account and a vendor account includes:
receiving account identification information;
receiving transaction specific information;
verifying the account identification information; and
determining whether the transaction is approved.

24. The method of claim 23, wherein receiving the account identification information includes:
receiving an address to be associated with the payment mechanism.

25. The method of claim 23, wherein receiving the account identification information includes:
receiving an identifier to be associated with the payment mechanism.

26. The method of claim 23, wherein receiving the transaction specific information includes:
receiving a transaction value.

27. The method of claim 24, wherein receiving the account identification information includes receiving an identifier to be associated with the payment mechanism, and wherein verifying account identification information includes:
comparing the address to be associated with the payment mechanism and the received identifier to the address associated with the account and the unique identifier assigned to the account.

28. The method of claim 27, wherein receiving the transaction specific information includes receiving a transaction value, and wherein, if the address to be associated with the payment mechanism and the received identifier match the address associated with the account and the unique identifier assigned to the account, the method further comprises:
determining a remaining balance for the account; and
determining whether the transaction value exceeds the remaining balance for the account.

29. A system for electronically facilitating a transaction via a payment mechanism for an account, the system comprising:
a server for facilitating payment via the payment mechanism;
a repository accessible by the server;
a network coupled to the server, wherein at least one vendor is accessible by the server via the network;
wherein an address is associated with the account;
wherein a unique identifier is assigned to the account;
wherein a funding amount associated with the account is received;
wherein the payment mechanism associated with the account is provided; and
wherein a transaction between the account and a vendor account is facilitated via the payment mechanism.

30. The system of claim 29, wherein the terminal is selected from a group consisting of a personal computer, a minicomputer, a main frame computer, a microcomputer, a hand held device, and a telephonic device.

31. The system of claim 29, wherein the server is selected from a group consisting of a personal computer, a minicomputer, a microcomputer, and a main frame computer.

32. The system of claim 29, wherein the server is coupled to the network via a coupling.

33. The system of claim 32, wherein the coupling is selected from a group consisting of a wired connection, a wireless connection, and a fiberoptic connection.

34. The system of claim 29, wherein repository is housed on the server.

35. A computer program product comprising a computer usable medium having control logic stored therein for causing a computer to facilitate a transaction via a payment mechanism for an account, the control logic comprising:
first computer readable program code means for associating an address with the account;
second computer readable program code means for assigning a unique identifier to the account;
third computer readable program code means for receiving a funding amount associated with the account;
fourth computer readable program code means for providing the payment mechanism associated with the account; and
fifth computer readable program code means for facilitating a transaction between the account and a vendor account via the payment mechanism.
